(19) United States
(12) Patent Application Publication
(10) Pub. No.: US 2026/0283170 A1
(43) Pub. Date: Sep. 24, 2026

(54) ELECTRIC PRESSURE CANNER WITH DIGITAL CONTROL

(71) Applicant: National Presto Industries, Inc., Eau Claire, WI (US)

(72) Inventors: Sawyer Berg, Eau Claire, WI (US); Julian Warwick, Jim Falls, WI (US)

(21) Appl. No.: 19/087,875

(22) Filed: Mar. 24, 2025

(51) Int. Cl. A23B 2/30; A23B 2/00; G05D 23/19; H05B 1/02

(52) U.S. Cl. CPC A23B 2/30; A23B 2/001; A23B 2/003; G05D 23/1951; H05B 1/0261

(57) ABSTRACT

Disclosed is an electric canner. The electric canner includes a control circuit, a heating assembly located within a pressure chamber portion of the electric canner, and a temperature sensor. The canner includes a chamber and lid that can be pressurized to allow temperatures inside the canner to exceed the boiling point of water in a non-pressurized environment. The control circuit controls the flow of power to the heating assembly in order to regulate the temperature inside the electric canner to achieve a desired temperature. The control circuit also includes a timer that indicates the time that the temperature inside the canner is at or above a desired level. The heating assembly and chamber are configured such that sounds and vibrations created by boiling water are minimized.

### CROSS REFERENCE TO RELATED APPLICATIONS

This application makes no claim of priority.

### TECHNICAL FIELD

The present invention relates generally to pressure canner appliances. More specifically, the present invention is directed to a digital pressure canner appliance that uses a thermal sensor to digitally measure internal steam temperature and control the application of heat to the pressure canner appliance so as to avoid large variations in internal temperature during the canning process.

### BACKGROUND

Residential canner appliances are well known and are frequently used to prepare food recipes in jars. Canner appliances are used to preserve food products in a jar by sterilizing the contents, removing oxygen from the food product and jar, and sealing the jar. Traditionally, two types of canning methods exist, water bath canning and pressure canning. Water bath canning is a relatively lower-temperature canning process typically used for high-acid foods including fruits and fruit juices, jams, jellies, salsas, tomato sauces, pickled foods, vinegars, and condiments. The high acidity of the foods kills the bacteria and microorganisms. Pressure canning is performed at a relatively higher temperature (240° F.) and pressure, and is used for low-acid foods including vegetables, meats, poultry, and seafood. The high internal temperature kills the bacteria and microorganisms. As such, the achievement and maintenance of temperature high enough to ensure that the bacteria and microorganisms are killed is of paramount importance.

In operation, traditional pressure canners are filled with the jar food to be sterilized and a small amount of water. Once the lid has been fixedly attached to the vessel, the vessel is placed on a heat source such as, for example, a stove top, wherein the heat source is set at a maximum output level. As the vessel is heated, the water begins to boil, which turns to steam, causing the pressure within the vessel begins to rise. The lid can include a mechanical pressure relief, for example, a weighted rocker or spring-based relief valve that begins to release pressure/steam above a desired setpoint. It is this relief of pressure and a corresponding rocking motion and whistling noise that indicates to a user that the appropriate temperature and pressure have been achieved for sterilization and the timing of the canning process can commence.

While the mechanical pressure relief adequately performs basic regulation functions, it can result in a very inefficient canning process. For instance, once satisfactory pressure is reached, there is no longer the necessity for the heat source to be set at the maximum level. However, the user has no reliable feedback regarding the heat source other than the motion, noise and steam associated with rocker and spring-based relief valves. In some instances, the noise may be so significant that the user reduces the heat source to the extent that the relief valves are no longer venting, which is an indication that pressure is no longer satisfactory and a potentially dangerous canning situation is occurring.

While prior digital canner appliances exist that are capable of water bath canning, the National Center for Home Food Preservation (funded by the USDA) has warned against using digital canner appliances for pressure canning. The main concern with digital pressure canner appliances regards the temperature for the preservation and sterilization of the food product. The temperature in prior digital pressure canner appliances tends to fluctuate due to the mounting location of the heat sensor. As the canner material functions as a large heat sink, the heat sensor is not exposed to real-time temperature conditions within the pressure canner and to which the food is actually exposed. As such, the temperature sensed by the heat sensor will always be lagging or leading with respect to the internal temperature conditions resulting in a heating element not being operated in the most efficient and desirable fashion. As such, large under and overshoots can be experienced with respect to internal canner temperature, which can potentially allow bacteria and microorganisms to survive the canning process and lead to food spoilage.

As such, it would be advantageous to have a digital pressure canner appliance that is able to sense steam temperature in a real-time environment and control a heat source with a minimal amount of delay between the application of power and a corresponding increase in water and steam temperature so as to ensure effective and safe pressure canning of food products.

### SUMMARY

A digital pressure canner of the present invention can provide for improved safety and consistency by reducing over and undershooting with respect to temperature control for a canning process. By reducing over and undershoot of internal canning temperatures, foods within the pressure canner are consistently maintained at the temperatures necessary to kill any bacteria or microorganisms throughout the entire canning cycle. Embodiments of the digital pressure canner include a temperature sensor adapted to measure an internal temperature within the pressure canner itself and to communicate the internal temperature in real-time to a temperature control. By measuring internal temperature in real time, the temperature control is able to control a heating element in conjunction with actual conditions inside the pressure canner and avoid temperature over and undershoot within the pressure canner. In some embodiments, a mechanical safety device, for example, a pressure relief valve can be utilized in conjunction with digital controllers and sensors to provide audible or physical indications that sufficient canning temperatures have been achieved.

In one aspect, the present invention is directed to a pressure canner that utilizes a digital controller and a digital sensor to reduce temperature over and undershoot during a canning cycle. The digital sensor is configured such that a sensing element is exposed to an interior canning environment within the pressure canner such that real-time steam temperature is communicated to the digital controller which provides power to the heating element in fluid communication with water in the pressure canner.

In another aspect, the present invention is directed to a method of canning food wherein a canning temperature is controlled with a digital controller and related digital sensors so as to reduce any temperature over or undershoot during a canning cycle. The method can comprise positioning a sensing element within an interior canning volume of a pressure canner such that real-time steam temperatures are communicated to the digital controller for selectively operating a heating element.

The above summary is not intended to describe each illustrated embodiment or every implementation of the invention. Rather, the exemplary embodiments are chosen and described so as to provide an overview or framework for understanding the nature and character of the claimed aspects and implementations so that those skilled in the art can appreciate and understand the principles and practices of the invention. The Figures and the detailed description that follow more particularly exemplify these exemplary embodiments, and are incorporated in and constitute a part of this specification.

### BRIEF DESCRIPTION OF THE DRAWINGS

These and other features and advantages of the present invention will become better understood with regard to the following description and accompanying drawings in which:

FIG. 1 is a front view of an electric pressure canner according to an exemplary embodiment;

FIG. 2 is a perspective view of the electric pressure canner of FIG. 1;

FIG. 3 is a cross-section view of the electric pressure canner of FIG. 1;

FIG. 4 is a view inside the pressure chamber portion of the electric pressure canner of FIG. 1;

FIG. 5 is a perspective view of a shelf portion of electric pressure canner of FIG. 1;

FIG. 6 is a perspective view of a heating assembly portion of electric pressure canner of FIG. 1;

FIG. 7 is a block diagram representing the electrical components of an exemplary pressure canner; and

FIG. 8 illustrates an alternate shelf design according to an exemplary pressure canner.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

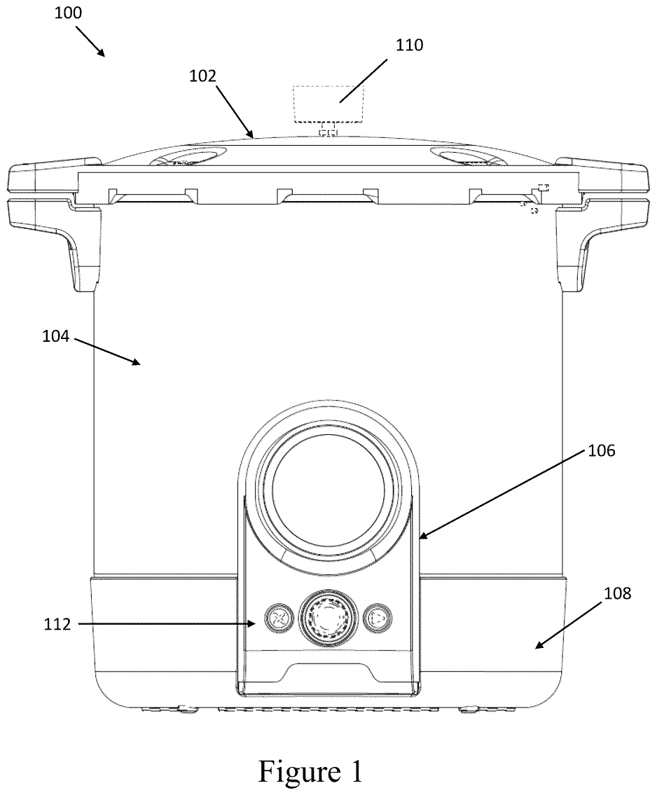

As illustrated in FIG. 1, an exemplary embodiment of an electric pressure canner 100 comprises a lid assembly 102, a pressure chamber assembly 104, a control and display assembly 106, a base 108, a weighted pressure limiting regulator 110, and operating controls 112.

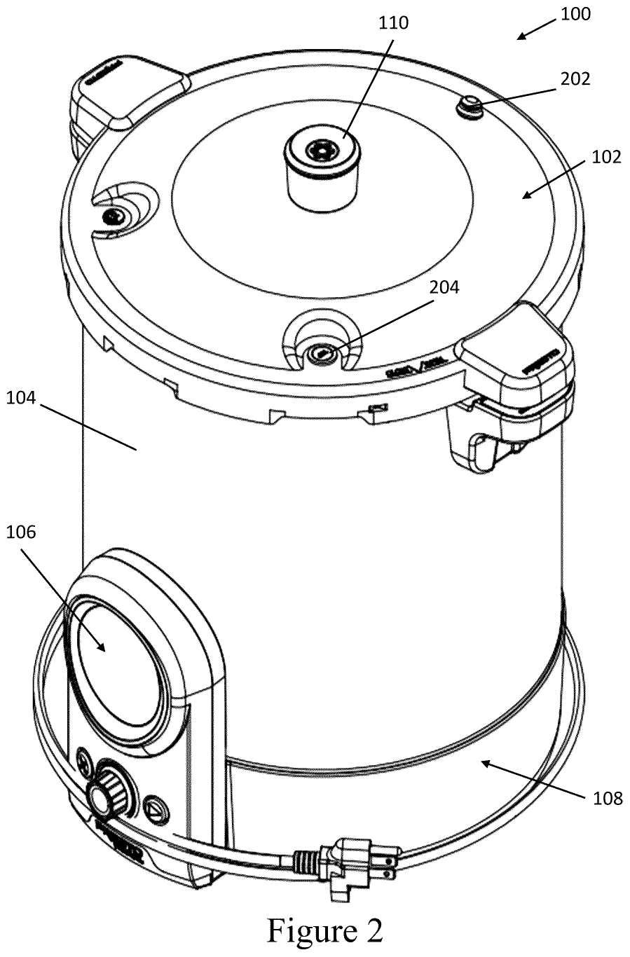

FIG. 2 shows a perspective view of the electric pressure canner 100 of FIG. 1. Visible in FIG. 2 are details of the lid portion 102 of the canner 100, including an overpressure relief valve 202 and a lid interlock 204. The overpressure relief valve 202 in an exemplary embodiment may be designed to function in a manner similar to an overpressure relief valve found in an ordinary stovetop pressure canner except that the interaction of the pressure limiting regulator 110 and the regulating controls associated with the control and display assembly 106 serve to make the overpressure relief valve 202 largely unnecessary. In an exemplary embodiment, a heat source, temperature sensor, and controller in communication with the heat source and temperature sensor (not illustrated in FIG. 2) serve to regulate the temperature and pressure found in the pressure chamber assembly 104 such that temperatures are limited to levels insufficient to produce hazardous pressures within the canner 100. Similarly, the weighted pressure limiting regulator 110 serves as a safety device in that it does not regulate pressure during ordinary canning operations as would be the case in a stovetop pressure canner. In an exemplary embodiment, the pressure limiting regulator 110 is configured to limit (regulate) the pressure level to a level that is higher than what would be required to achieve the required temperatures to safely process foodstuffs for canning but well below pressures that would be dangerous. In such an exemplary embodiment, the pressure limiting regulator 110 is adapted to limit pressures to a maximum pressure in a range starting at 18 pounds per square inch and ending at a pressure that is less than the maximum safe pressure of the chamber assembly 104 or 24 pounds per square inch, whichever is lower.

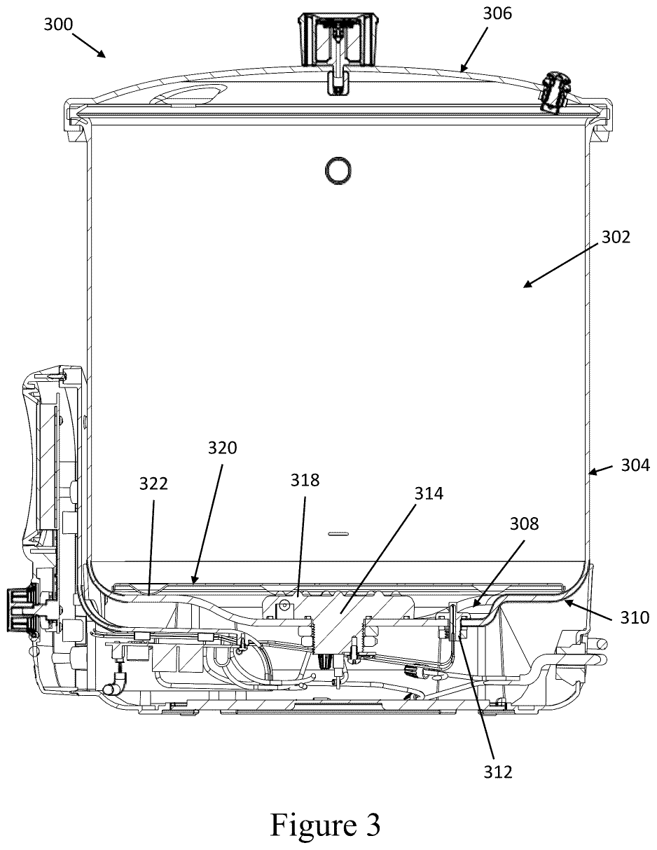

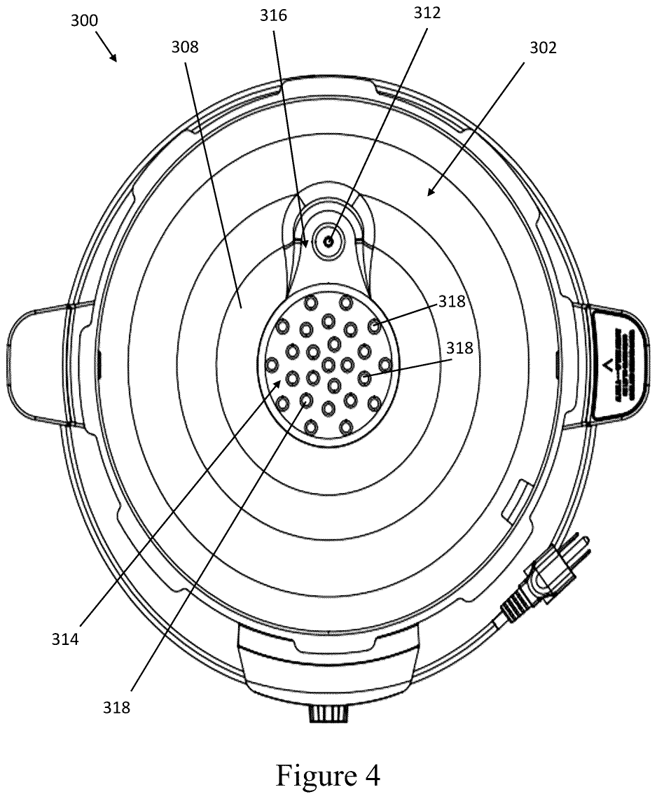

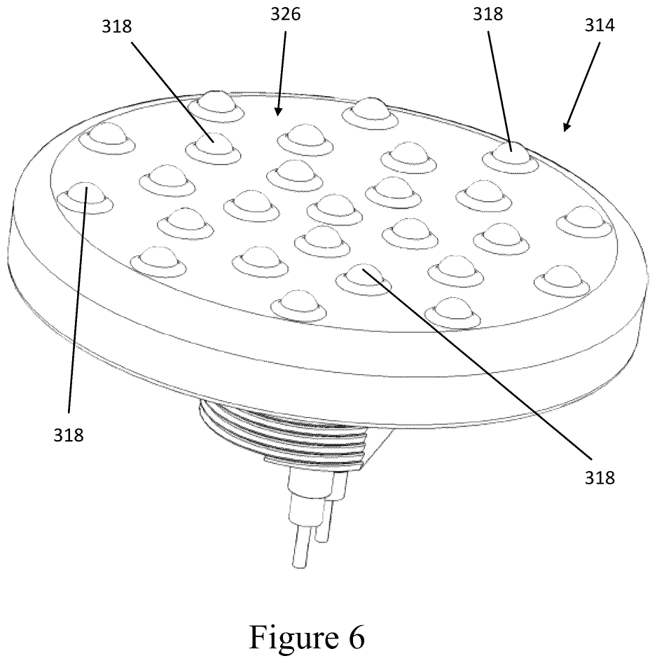

As is understood by those of ordinary skill in the art, pressure canners operate by using a sealed enclosure to allow pressure to build sufficiently to raise the boiling point of water to temperatures required for safe processing of canned foods. In conventional countertop canners, the temperature is regulated by achieving and maintaining a predetermined pressure using a weighted regulator. Using pressure to regulate temperature requires a user to be aware of the altitude at which the canner is being operated in order to adjust the pressure to achieve the desired temperature. Referring to the cross-section view of an exemplary embodiment shown in FIG. 3, an electric canner 300 regulates the temperature of a pressure chamber 302 directly by sensing, using at least one temperature sensor, the temperature in a pressure chamber 302 of the canner 300. As illustrated in FIG. 3, the pressure chamber 302 comprises a side wall portion 304, a lid portion 306, and a floor portion 310. In the exemplary embodiment, the floor portion 310 comprises a well 308 that forms a recess in the floor portion 310. In an exemplary embodiment, a temperature sensor 312 is positioned within the well 308. Also positioned within the well 308 is a heating assembly 314. An exemplary embodiment of the heating assembly 314 comprises a heating coil through which an electric current is passed to produce heat. FIG. 6 illustrates a heating assembly 314 illustrated separately from the pressure chamber 302. The exemplary heating assembly 314 is shown in a circular configuration however, other shapes can be used in certain embodiments. Additionally, in certain embodiments, a plurality of heating assemblies 314 can be used. FIG. 4 shows an alternate view of the electric canner 300. In this view, the well 308 is illustrated from a view looking inside the pressure chamber with the lid assembly 306 removed. As illustrated, in certain exemplary embodiments, the temperature sensor 312 is located within a sub-well portion 316 located at least partially within the well 308. In other exemplary embodiments, the well 308 is enlarged such that the sensor 312 is located with the well 308 without the need for a sub-well portion.

Previously known electric pressure canners utilized heating elements that were located externally to the pressure chamber and communicated heat into the pressure chamber through the pressure chamber walls. Additionally, such heating elements required heat spreaders to avoid hot spots on the pressure chamber walls. The result was that the transmission of heat energy to the interior of the pressure chamber lagged behind the application of power to the heating element, causing difficulty with regard to controlling temperatures within the pressure chamber. In order to more closely regulate temperatures in the pressure chamber, prior electric canner controls would attempt to anticipate the delay between the application of power to the heating element and a temperature change inside the pressure chamber. Different amounts of foodstuffs or cans inside the pressure chamber change the amount of delay, making anticipating and, thus, precise control very difficult. In exemplary embodiments, the heating assembly 314 is positioned inside the pressure chamber 302 in direct contact with water which is heated to form steam. Testing has determined that once the air in the pressure chamber 302 is completely replaced with steam from heated water, the water temperature and steam temperature are the same. Thus, sensing the water temperature accurately reflects the temperature inside the pressure chamber 302, and placing the heating assembly 314 in direct contact with the water allows for less delay between the application of power to the heating assembly 314 and a change in water temperature. The result is a significantly improved ability to regulate the temperature within the pressure chamber 302.

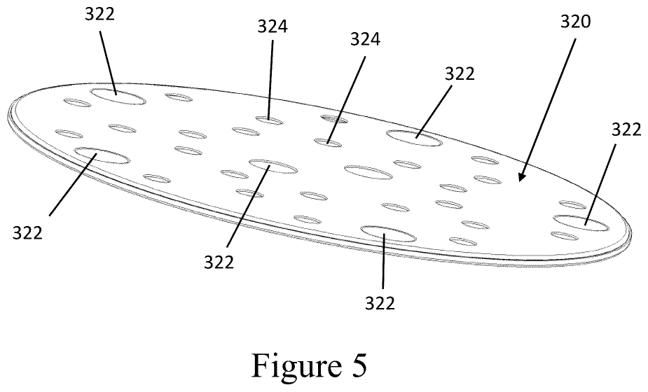

Referring to FIG. 3, which shows a cross-section view of the electric canner 300, a shelf 320 is positioned at the lower portion of the pressure chamber 302. In an exemplary embodiment, the shelf 320 is suspended above the floor portion 310 by a plurality of foot portions 322. These foot portions 322 serve to provide a consistent space between the floor portion 310 and canning jars placed in the pressure canner. In addition, the foot portions 322 serve to provide spacing between the heating assembly 314 and canning jars resting on the shelf 320. FIG. 5 illustrates an exemplary view of a shelf 320. In the illustrated embodiment, a series of perforations 324 are formed in the shelf 320. In the illustrated example, the perforations are primarily one size with two perforations being larger in diameter. These larger perforations enable a user to lift the shelf 320 from the pressure chamber 302. In certain exemplary embodiments, the perforations are randomly distributed on the shelf 320 while in other exemplary embodiments, the perforations are formed with two or more distinct diameters.

Referring to again to FIG. 3, the shelf 320 is positioned above the heater assembly 314 at the bottom of the canner housing 304. In use, the canner housing 304 is partially filled with water such that the water found in the bottom of the canner housing 304 fills the space between the shelf 320 and the heater assembly 314 with a surface level that is above the upper surface of the shelf 320, where the lower surface of the shelf 320 faces the heater assembly 314 and the upper surface of the shelf 320 faces away from the heater assembly 314. In use, canning jars are in contact with the shelf 320 and partially surrounded by the water in the canner housing 304. As the water is heated by the heater assembly 320, steam bubbles are formed. As these bubbles expand, they move toward the surface of the water, traveling between the heater assembly 314 and the shelf 320. Some bubbles move along the lower surface of the shelf 320 while others escape the space between the shelf 320 and the heater assembly 314 by flowing through holes 324 found in the shelf 320. As these bubbles move, they cause the shelf 320 to vibrate or rattle. The sound of the rattling as well as any sounds caused by the bubbles themselves can be disconcerting to users of an electric canner 300. Additionally, the movement of larger bubbles through the shelf 320 and holes 324 can cause canning jars located in the canner housing 304 to rattle and knock against each other. This knocking is undesirable in that it could disturb the seal between the canning jar and its lid. In order to mitigate the risk of damaging the seal of a canning jar and disturbing those persons located proximately to the canner, protrusions 318 are formed on the heat assembly 314. Visible in FIGS. 3, 4, and 6 are exemplary protrusions 318 formed on the upper surface of the heating assembly 314. In certain exemplary embodiments, these protrusions extend above the upper surface in a range from 0.090 to 0.160 inches. These protrusions function to cause the steam bubbles to separate into smaller bubbles and also to slow down the bubbles as they move from the heater assembly 314 along and through the shelf 320 toward the water surface. By creating smaller, slower-moving steam bubbles, the protrusions 318 reduce the movement of the canning jars and also the noise generated by the bubbles as they move through the water. As illustrated in FIG. 3, in exemplary embodiments, the upper surface of the protrusions 318 approaches a lower surface of the shelf 320. In certain of these embodiments, the distance between the upper surface of the protrusions 318 and the lower surface of the shelf ranges from 0.080 to 0.250 inches. In addition, in certain exemplary embodiments, the protrusions 318 improve water circulation around the heating assembly 314, improving the ability of the heating assembly to evenly heat water in the pressure chamber 302.

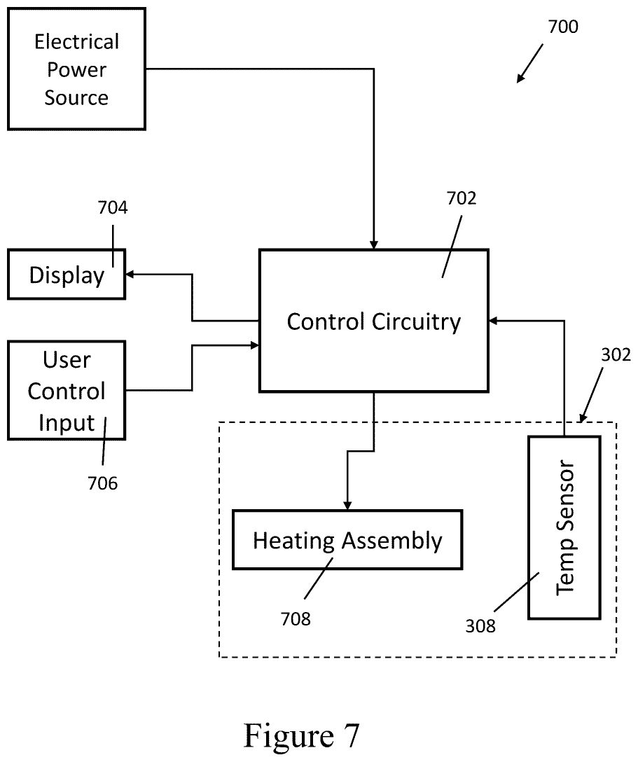

FIG. 7 illustrates a block diagram 700 of the electrical circuitry of the electric canner 100. As is shown, an exemplary control portion is comprised of control circuitry 702, a display 704, and user inputs 706. The control circuitry 702 receives electrical power from an electrical power source (for example, a wall outlet). This electrical power is provided to the heating assembly 708 by the control circuitry 702. The control circuitry 702 received signals from a temperature sensor 308 representing the temperature inside of the canner housing 304 and controls the heating assembly 708 to achieve a temperature set point that is received from the user control inputs 706. Alternatively, the temperature set point could be found in a memory of the control circuitry 702 which represents a process or recipe for canning a certain type of food. For example, for a certain food, a temperature of 242 degrees must be maintained for 30 minutes. Thus, if a set point is 242 degrees Fahrenheit and the temperature sensor 308 reads 220 degrees, the control circuitry 702 causes electrical power to flow from the electrical power source to the heating assembly 708. The heating assembly transfers heat into the water, raising the temperature of the water until the temperature sensor 308 senses a temperature equal to the set point. Once the set point is achieved, the control circuitry 702 stops the power flow to the heating assembly 708. In certain exemplary embodiments, the control circuitry 702 can anticipate the rise of the water temperature sensed by the temperature sensor to account for a delay caused by the time that the increase or decrease in temperature propagates through the water from the heating assembly 708 to the temperature sensor 308. This anticipation can be a fixed value that causes power to stop flowing to the heating assembly 708 once a temperature is measured that is equal to the set point temperature less a predetermined amount. In another exemplary embodiment, the control circuitry 702 can monitor the temperature rise as a function of time when the heating assembly 708 is energized. This is done to determine the rate of rise of the sensed temperature such that a difference between the set point and measured temperature can be set to anticipate the further rise of the sensed temperature after the control circuitry 702 limits the power delivered to the heating assembly 708. Such a method can use used to avoid or minimize the temperature of the water in the canner overshooting the set point temperature. As was previously discussed, exemplary embodiments position the heating assembly 708 inside the pressure chamber 302, reducing the need to anticipate temperature rise and thus, improving temperature regulation.

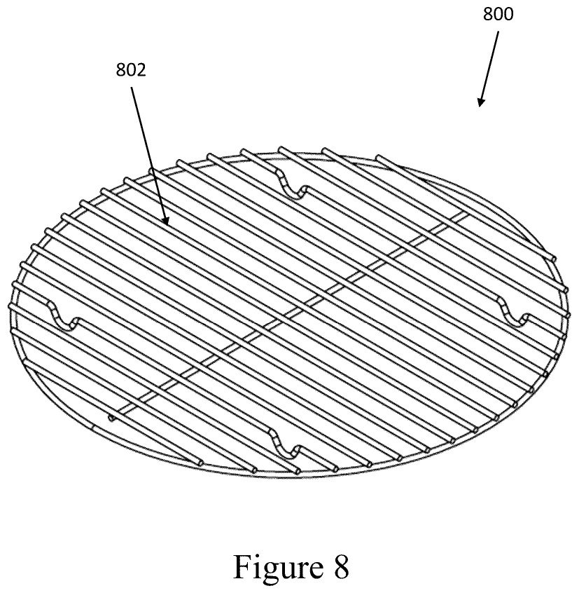

FIG. 8 represents an alternate embodiment of a shelf 800 which is arranged on the floor portion 310 of the electric canner 300. As shown, this embodiment of the shelf 800 is formed from wire portions 802 to form an open rack design. This arrangement allows for an increased level of water circulation from the heating assembly 314 into the pressure chamber 302, further improving temperature response to the heating assembly 314 and, thus, temperature regulation by the electric canner 300.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

Any implementation or embodiment disclosed herein can be combined with any other implementation or embodiment, and references to “an implementation,” “some implementations,” “one implementation,” “an embodiment,” “some embodiments,” “certain embodiments,” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation or embodiment can be combined with any other implementation or embodiment, inclusively or exclusively, in any manner consistent with the aspects and implementations disclosed herein.

Where technical features in the drawings, detailed description or any claim are followed by reference numbers, the reference numbers have been included to increase the intelligibility of the drawings, detailed description, and claims. Accordingly, neither the reference numbers nor their absence have any limiting effect on the scope of any claim elements.

Coupled elements can be electrically, magnetically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the Figures. The orientation of various elements may differ according to other exemplary embodiments, and that such variations are intended to be encompassed by the present disclosure.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

What is claimed is:

1. A canner for canning foodstuffs comprising:
a lid assembly;
a pressure chamber;
a control assembly;
a heating assembly;
a temperature sensor, the temperature sensor in electrical communication with the control assembly, the control assembly in electronic communication with the heating assembly such that electrical power is provided to the heating assembly; and
the heating assembly comprising a plurality of protrusions on a surface of the heating assembly.

2. The canner of claim 1, further comprising a shelf portion adapted to rest at a bottom portion of the pressure chamber, the shelf portion being suspended above the heating assembly.

3. The canner of claim 1, wherein the pressure chamber comprises a floor portion which comprises a well portion adapted to contain the heating assembly and the temperature sensor.

4. The canner of claim 2, wherein the shelf portion and the plurality of protrusions of the heating assembly are adapted such that the shelf portion does not make contact with the protrusions when the shelf portion is resting at the bottom portion of the pressure chamber.

5. The canner of claim 1, further comprising a pressure limiting regulator that is configured to regulate at a pressure that is higher than pressures occurring when the control assembly is functioning as intended.

6. The canner of claim 1, wherein the pressure limiting regulator is configured to limit a pressure in the pressure chamber to a pressure that is in a range from 18 to 20 pounds per square inch.

7. The canner of claim 1, wherein the protrusions of the heating assembly extend from the heating assembly surface a length ranging from 0.090 to 0.160 inches.

8. The canner of claim 1, where the protrusions of the heating assembly have an upper surface spaced below a lower shelf surface in a range from 0.080 to 0.250 inches.

9. A method of canning foodstuffs comprising the steps of:
placing a shelf into a pressure chamber portion of an electric canner, where the shelf rests on a floor portion of the pressure chamber portion, the shelf being suspended above a heating assembly, the heating assembly located in a well portion formed in the floor portion of the pressure chamber portion;
adding water to the pressure chamber portion;
placing a lid assembly onto the pressure chamber portion;
causing electric power to warm the heating assembly until a temperature sensor measures a predetermined temperature; and
maintaining the predetermined temperature by monitoring the temperature sensor.

10. The method of claim 9, wherein the heating assembly comprises a plurality of protrusions.

11. An electric pressure canner control system, the system comprising:
a controller;
a temperature sensor;
a pressure chamber and lid assembly configured to permit pressurization of the interior of the pressure chamber;
a heater assembly located within the pressure chamber and lid assembly; and
the controller in electronic communication with the heater assembly and the temperature sensor such that the controller provides electric power to the heater assembly to cause a temperature and pressure increase within the pressure chamber and lid assembly to achieve a predetermined temperature level.

12. The electric pressure canner control system of claim 11, wherein the heater assembly comprises a plurality of protrusions on an upper surface of the heater assembly.

13. The electric pressure canner control system of claim 11, wherein the heating assembly and the temperature sensor are positioned within a well portion of the pressure chamber.

14. The electric pressure canner control system of claim 11, further comprising controls and a display in electric communication with the controller.

15. The electric pressure canner control system of claim 11, wherein the protrusions of the heating assembly extend a distance ranging from 0.090 to 0.160 inches from the heating assembly surface.

16. The electric pressure canner control system of claim 11, further comprising a pressure limiting regulator that is configured to regulate at a pressure that is higher than pressures occurring when the controller is functioning as intended.

17. The electric pressure canner control system of claim 16, wherein the pressure limiting regulator is configured to limit a pressure in the pressure chamber to a pressure that is in a range from 18 to 20 pounds per square inch.
